(19) United States
(12) Patent Application Publication
(10) Pub. No.: US 2008/0268087 A1
(43) Pub. Date: Oct. 30, 2008

(54) Locking Structure for Molded Parts in a Molding Machine

(75) Inventor: Derek Robertson McCready, Mississauga (CA)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, CA

(73) Assignee: HUSKY INJECTION MOLDING SYSTEMS LTD., Bolton (CA)

(21) Appl. No.: 11/741,830

(22) Filed: Apr. 30, 2007

(51) Int. Cl. B29C 49/64

(52) U.S. Cl. 425/526; 425/537

(57) ABSTRACT

Disclosed herein is a mold including a first mold half, a second mold half and a retainer plate. The first and second mold halves are configured to open and close. The first and second mold halves are configured to capture a molded part therebetween when closed. The retainer plate is positioned between the first and second mold halves and defines an aperture having a first aperture portion that is sized to prevent the pass-through of the molded part, and a second aperture portion that is sized to permit the pass-through of the molded part during opening of the first and second mold halves. The retainer plate is movable to control which of the first and second aperture portions is aligned with the molded part.

### TECHNICAL FIELD

The present invention generally relates to molding machines, and more specifically the present invention relates to a system for retaining molded parts in a cooling cavity in a molding machine.

### BACKGROUND OF THE INVENTION

Injection molding machines are used to mold a wide variety of parts, such as, for example, beverage container preforms. It is generally advantageous for a molding machine to have a short cycle time, in order to increase the number of parts molded per unit of time. A cycle is typically made up of an injection phase, a holding phase and a cooling phase. The cooling phase may be significantly longer than the other phases and may thus be a critical component in determining the overall cycle time.

Many schemes have been developed in order to reduce the impact of cooling on the cycle time for molding machines. Some schemes involve the removal of the parts from the mold cavities and transfer to other holding areas for further cooling, so that new parts could be made in the mold cavities. In general, such schemes involve complex mechanisms which can impact the reliability of the machine. Additionally some of these schemes result in a significantly increased footprint for the machine. Some other schemes involve expensive additional equipment.

U.S. Pat. No. 5,051,227 (Brun, Jr., et al.) proposes a method of production of preforms, whereby a plurality of injection cores are inserted by a movable platen into corresponding injection cavities defined by mold inserts within a stationary platen, and the cores extend through corresponding split transfer mold cavities. After hollow preforms with threaded neck portions are molded within the cavities, the preforms are removed from the mold cavities, separated from the injection cores, and then shifted transversely by the split transfer molds to cooling or blow cavities defined by blow cavity inserts within the stationary platen on opposite sides of the corresponding injection cavities. The transfer molds return to receive the injection cores, and corresponding blow core units are inserted into the preforms within the blow cavities for pressurizing and expanding the preforms into firm contact with the blow inserts. The preforms are removed from the blow cavities by the blow cores in alternate cycles of press operation and are then released by retraction of the blow cores. The split transfer molds are shifted transversely in opposite directions and are opened and closed by a cam system which includes cam tracks mounted on the movable platen and incorporating cam track switches.

U.S. Pat. No. 4,540,543 (Thomas, et al.) proposes a method and apparatus for injection blow molding hollow plastic articles characterized by a rapid and efficient operating cycle. The injection mold includes a mold cavity and the blow mold is located adjacent the mold cavity in side-by-side relationship. The parison is injection molded into the mold cavity onto a core. The parison on the core is separated from the mold cavity by moving the parison on the core axially in a straight path away from the mold cavity, followed by movement in a substantially arcuate path into axial alignment with the blow mold, followed by axial movement in a straight path into said blow mold.

U.S. Pat. No. 6,887,418 (Olaru, et al.) proposes post-mold cooling of injection molded plastic articles such as preforms by transferring the articles directly from the mold cavities onto cooling cores carried by a take-out plate. The molded articles are supported on the cooling cores until they become sufficiently frozen that they can be stripped from the cores.

PCT Patent application publication no. WO2005009718 (Atance Orden) proposes an apparatus for the production of preforms by means of molding. The apparatus consists of: a cavity block comprising lines of injection cavities which are disposed between lines of cooling cavities; a punch block comprising a punch support plate having twice as many lines of punches as lines of injection cavities; and an ejection plate assembly comprising slides in which are formed respective halves of the mold necks and ejection elements, said slides being equipped with opening and closing means. According to the invention, means are provided in order to move the punches cyclically from the injection cavities and the cooling cavities to the cooling cavities and the injection cavities, such that some preforms are cooled in the cooling cavities while other preforms are injected into the injection cavities, said process being performed in a cyclic manner.

### SUMMARY OF THE INVENTION

The technical effect realized by at least some of the embodiments of the present invention and variations and alternatives thereof may include providing a mold with cooling cavities adjacent mold cavities, wherein the molded parts may be cooled on cores, and may have the cores removed therefrom after a selected amount of cooling without the need for split inserts.

In a first aspect, the invention is directed to a mold including a first mold half, a second mold half and a retainer plate. The first and second mold halves are configured to open and close. The first and second mold halves are configured to capture a molded part therebetween when closed. The retainer plate is positioned between the first and second mold halves and defines an aperture having a first aperture portion that is sized to prevent the pass-through of the molded part, and a second aperture portion that is sized to permit the pass-through of the molded part during opening of the first and second mold halves. The retainer plate is movable to control which of the first and second aperture portions is aligned with the molded part.

### DESCRIPTION OF THE DRAWINGS

A better understanding of the embodiments of the present invention (including alternatives and/or variations thereof) may be obtained with reference to the detailed description of the embodiments along with the following drawings, in which:

FIG. 1a is a sectional plan view of a mold in accordance with an embodiment of the present invention, in a first position;

FIG. 1b is a magnified sectional plan view of a portion of the mold shown in FIG. 1a;

FIG. 1c is a magnified elevation view of another portion of the mold shown in FIG. 1a;

FIG. 1d is a magnified elevation view of another portion of the mold shown in FIG. 1a;

FIG. 1e is a plan view of the mold shown in FIG. 1a, with certain components omitted for greater clarity;

FIG. 2a is a sectional plan view of the mold shown in FIG. 1a, in a second position;

FIG. 2b is a magnified sectional plan view of the portion of the mold shown in FIG. 1b, in the second position;

FIG. 3 is a magnified sectional plan view of the mold shown in FIG. 1a, in a third position;

FIG. 4a is a sectional plan view of the mold shown in FIG. 1a, in a fourth position;

FIG. 4b is a magnified sectional plan view of the portion of the mold shown in FIG. 1b, in the fourth position;

FIG. 5a is a sectional plan view of the mold shown in FIG. 1a, in a fifth position;

FIG. 5b is a magnified sectional plan view of the portion of the mold shown in FIG. 1b, in the fifth position;

FIG. 6 is a magnified sectional plan view of the portion of the mold shown in FIG. 1b, in the fifth position, illustrating the ejection of molded parts therefrom;

FIG. 7 is a sectional plan view of the mold shown in FIG. 1a, in a sixth position;

FIG. 8a is a sectional plan view of the mold shown in FIG. 1a, in a seventh position;

FIG. 8b is a magnified sectional plan view of the portion of the mold shown in FIG. 1b, in the seventh position;

FIG. 9a is a sectional plan view of the mold shown in FIG. 1a, in an eighth position;

FIG. 9b is a magnified sectional plan view of the portion of the mold shown in FIG. 1b, in the eighth position;

FIG. 10a is a sectional plan view of the mold shown in FIG. 1a, in a ninth position;

FIG. 10b is a magnified sectional plan view of the portion of the mold shown in FIG. 1b, in the ninth position;

FIG. 11a is a sectional plan view of the mold shown in FIG. 1a, in a tenth position;

FIG. 11b is a magnified sectional plan view of the portion of the mold shown in FIG. 1b, in the tenth position;

FIG. 12 is a magnified sectional plan view of the portion of the mold shown in FIG. 1b, in the tenth position, illustrating the ejection of molded parts therefrom; and

FIG. 13 is a sectional plan view of the mold shown in FIG. 1a, in an eleventh position.

### DETAILED DESCRIPTION OF EMBODIMENTS

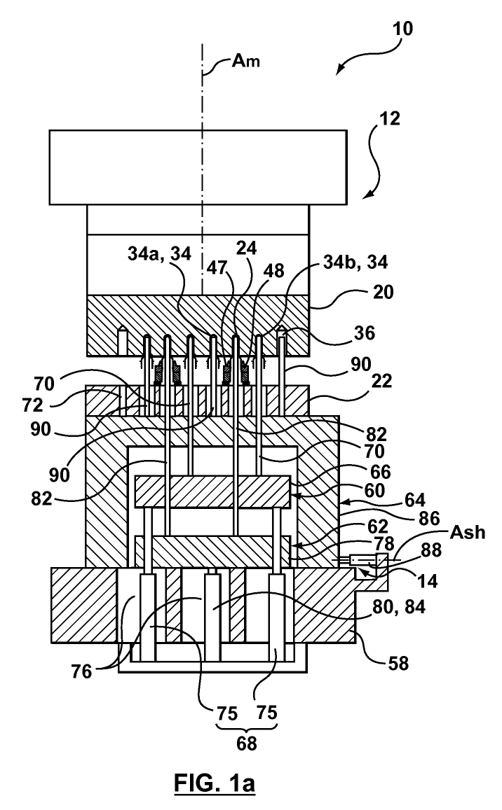

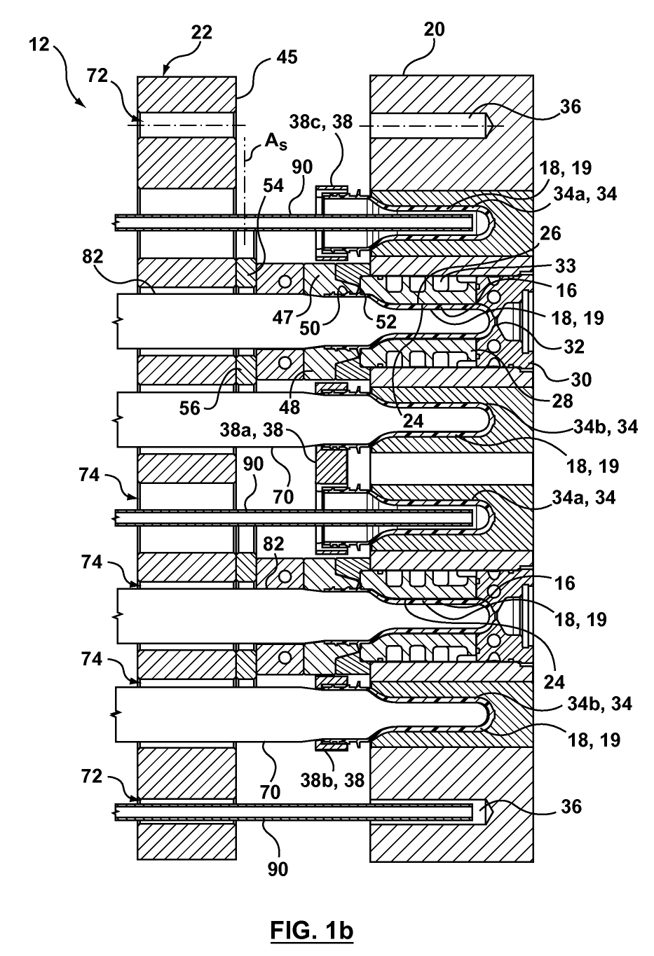

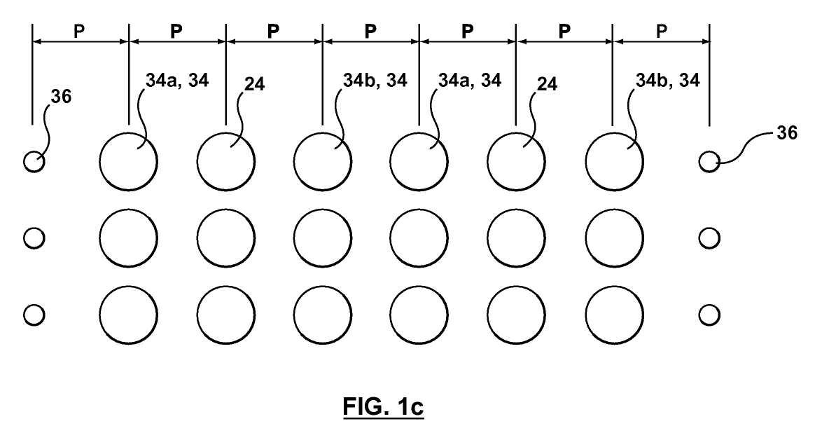

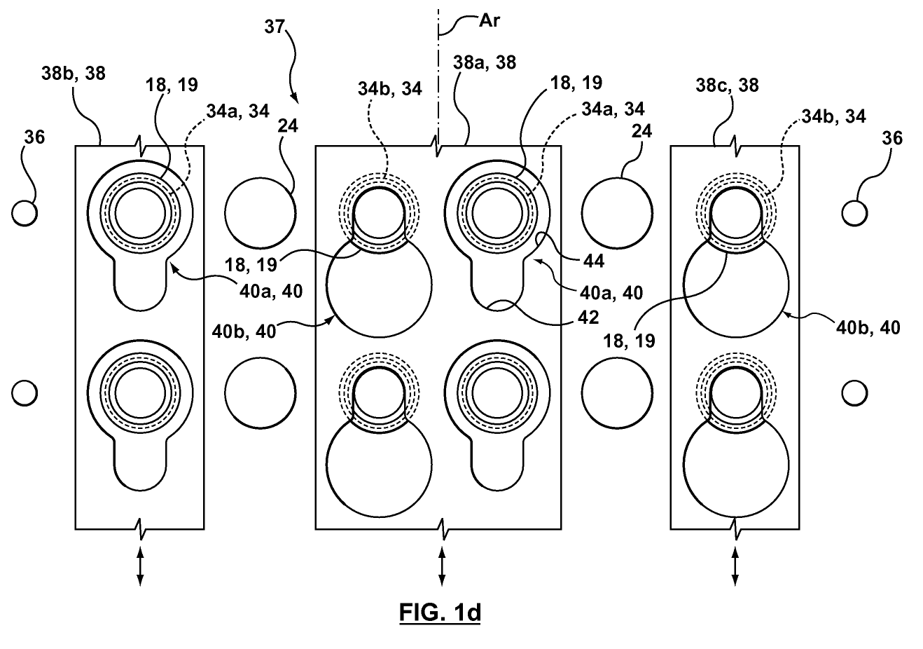

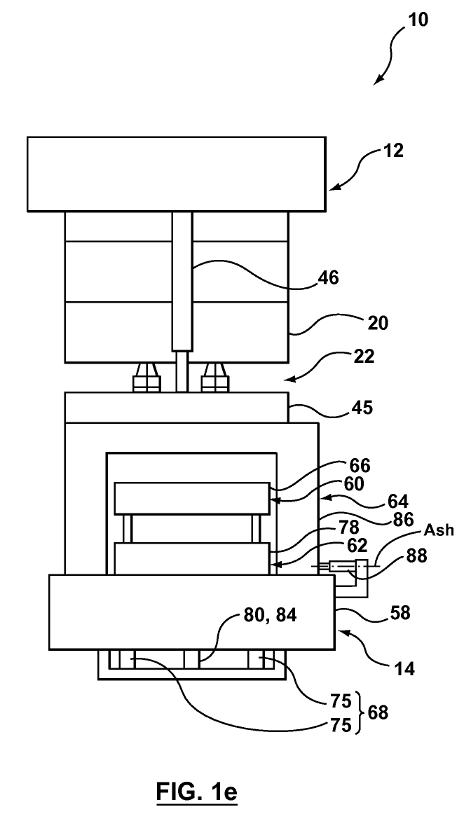

Reference is made to FIG. 1a, which shows a mold 10 in accordance with an embodiment of the present invention. One skilled in the art will appreciate that the mold 10 along with other equipment can form part of an injection molding machine (not depicted), which together with further equipment can form part of an injection molding system (not depicted).

The mold 10 includes a first, or stationary, mold half 12 and a second, or movable, mold half 14, which mate together to form a plurality of mold cavities 16 for producing molded parts 18 (see FIG. 1b). The molded parts 18 may be any suitable molded parts, such as, for example, beverage container preforms 19 or parisons. One skilled in the art will appreciate that the number of mold cavities 16 may be any suitable number, such as, for example, 48, 96, 144, 216 mold cavities and the like. It is possible for there to be as few as one mold cavity 16 to be formed by the first and second mold halves 12 and 14 (FIG. 1a).

The first mold half 12 is the stationary mold half. Referring to FIG. 1b, the first mold half 12 includes a first mold half base 20. The first mold half base 20 includes a plurality of first mold half cavity portions 24. The first mold half cavity portions 24 may be female mold cavity portions as shown in FIG. 1b. Each first mold half cavity portion 24 may define any suitable portion of the molded parts 18. For example, in embodiments wherein the molded part 18 is a beverage container preform 19, the first mold half cavity portion 24 may define the exterior wall shown at 26, of the beverage container preform 19.

The first mold half cavity portion 24 may be defined directly in the first mold half base 20, or alternatively in a mold insert 28 that is connected to the first mold half base 20. A gate insert 30 may be used to define a gate 32 into the mold cavity 16 and to define a portion of the first mold half cavity portion 24. A fluid conduit 33 for transporting coolant may be provided in proximity to the mold cavity 16 to assist in cooling molded parts 18 in the mold cavity 16. In embodiments wherein a mold insert 28 is used, the fluid conduit 33 may be provided on the periphery of the mold insert 28, as shown in FIG. 1b.

The first mold half base 20 further includes a plurality of cooling cavities 34. In the embodiment shown in FIG. 1b, the first mold half base 20 includes two cooling cavities 34 for each first mold half cavity portion 24. A first cooling cavity 34a is positioned on one side of each first mold half cavity portion 24 and a second cooling cavity 34b is positioned on the other side of the first mold half cavity portion 24. The cooling cavities 34 and the first mold half cavity portions 24 are positioned in alignment with each other in one or more rows on the first mold half base 20 (one such row is shown in FIG. 1b, a plurality of rows are shown in FIG. 1c). The first and second cooling cavities 34a and 34b may be identical, except that in a sequence of operations, molded parts 18 are transferred alternately from the first mold half cavity portions 24 into the first cooling cavities 34a and from the first mold half cavity portions 24 into the second cooling cavities 34b.

At the ends of each row are optional dummy cavities 36, which are described further below.

It will be noted that, between any two first mold half cavity portions 24 there are two cooling cavities 34, one of which is a first cooling cavity 34a and one of which is a second cooling cavity 34b. It will be further noted that at a first end of each row is a dummy cavity 36 adjacent a first cooling cavity 34a, which is itself adjacent a first mold half cavity portion 24. At a second end of each row is a dummy cavity 36 adjacent a second cooling cavity 34b, which is itself adjacent a first mold half cavity portion 24.

Referring to FIG. 1c, the pitch between adjacent apertures on the first mold half base 20 is shown at P and is constant. In other words, the pitch between the first mold half cavity portion 24 and each of the adjacent first and second cooling cavities 34a and 34b is the same as the pitch between the first cooling cavity 34a and any adjacent cooling cavity 34b, which is the same as the pitch between any dummy cavity 36 and any adjacent first cooling cavities 34a or second cooling cavities 34b.

After sufficient initial cooling in the mold cavities 16, molded parts 18 are removed from the mold cavities 16 and are cooled further in the cooling cavities 34, thereby freeing up the mold cavities 16 to be used for molding new molded parts 18. Coolant may be circulated in fluid conduits (not depicted) proximate the cooling cavities 34 to assist in cooling the molded parts 18 contained therein.

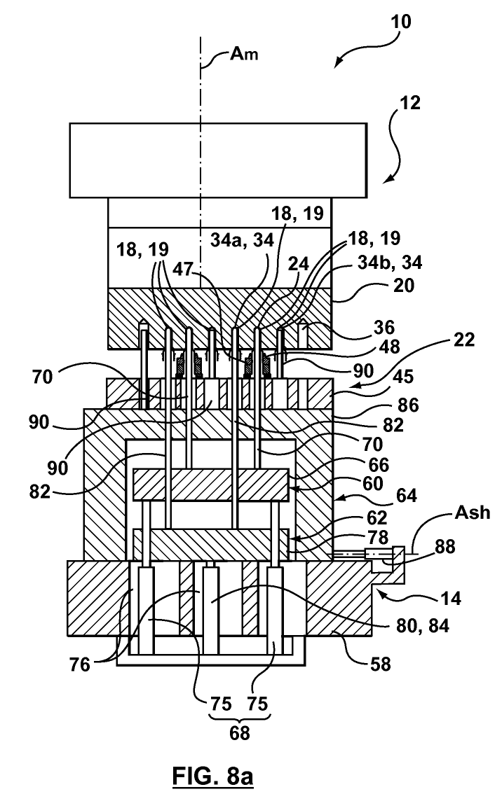

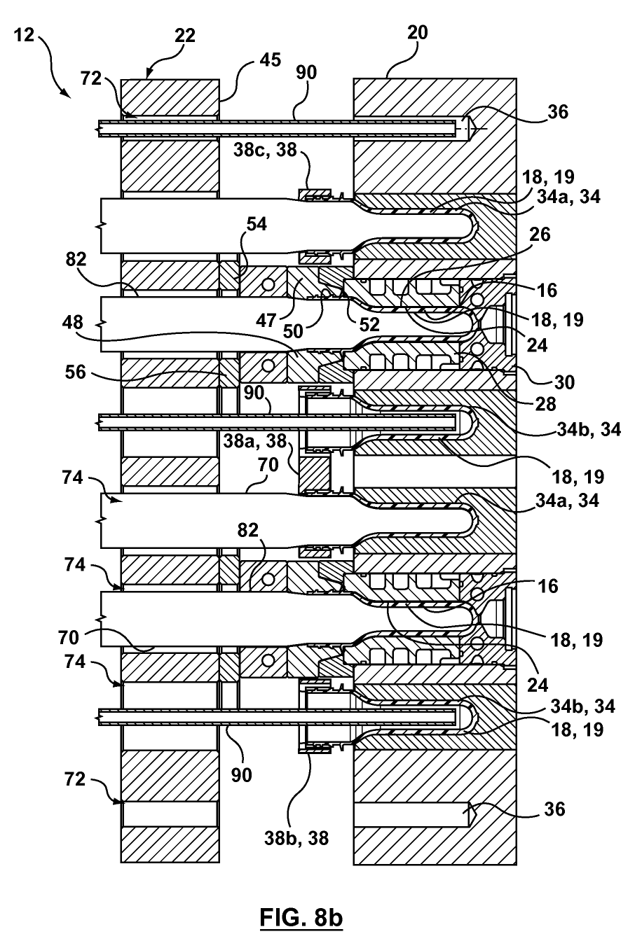

Referring to FIG. 1d, a retainer assembly 37 comprising a set of retainer plates 38 is mounted for movement relative to the first mold half base 20. The retainer plates 38 may include middle retainer plates 38a, first end retainer plates 38b and second end retainer plates 38c. The retainer plates 38 have sets of apertures 40 that are generally keyhole-shaped. A set of first apertures 40a are provided for the molded parts 18 held in the first cooling cavities 34a. A set of second apertures 40b are provided for the molded parts 18 held in the second cooling cavities 34b. The apertures 40 have a small diameter portion 42 which is sized to prevent the pass-through of the molded part 18 and thereby prevent the removal of the molded part 18 from its cooling cavity 34 while still providing room for the pass-through of a cooling device (eg. a cooled first or second sub-assembly core 82 or 70 or a blow tube 90 as shown in FIG. 1b or 8b respectively, which are all described further below) into the interior of the molded part 18, and a large diameter portion 44 which is sized to permit the pass-through of the molded part 18 and the cooling device (eg. a cooled first or second sub-assembly core 82 or 70 or a blow tube 90) and thereby permit the removal of molded part 18 from its cooling cavity 34.

The retainer plates 38 are movable between two positions along an axis, shown at Ar, that is normal to the mold opening axis of the machine, shown at Am in FIG. 1a. The axis Ar may be, for example, a vertical axis. When the retainer plates 38 are in a first position, shown in FIG. 1d, the first apertures 40a are positioned with their large diameter portions 44 in front of the molded parts 18 in the first cooling cavities 34a, and the second apertures 40b are positioned with their small diameter portions 42 in front of the molded parts 18 in the second cooling cavities 34b. In a second position (see FIG. 8b), the first apertures 40a are positioned with their small diameter portions 42 in front of the molded parts 18 in the first cooling cavities 34a, and the second apertures 40b are positioned with their large diameter portions 44 in front of the molded parts 18 in the second cooling cavities 34b. The retainer plates 38 are all linked together by any suitable means, such as by connector bars extending horizontally above and below the mold cavity area of the first mold half base 20 and may be driven by any suitable actuator, such as by a hydraulic cylinder (not shown), between their first and second positions.

In an alternative embodiment, the retainer assembly 37 could be configured to have retainer plates that move horizontally instead of vertically. The apertures in such an embodiment would be oriented at 90 degrees relative to their orientation shown in FIG. 1d.

The retainer plates 38 are omitted from FIGS. 1a, 2a, 4a, 5a, 7, 8a, 9a, 10a , 11a and 13 for greater clarity of those figures.

A stripper assembly 22 is provided, and may be associated with either of the first and second mold halves 12 and 14. Referring to FIG. 1b, the stripper assembly 22 includes a stripper plate 45, a stripper plate driver 46 (FIG. 1e) and a plurality of pairs of first split inserts 47 and second split inserts 48. Referring to FIG. 1b, each pair of inserts 47 and 48 cooperate to form a portion of the molded part. For example, in embodiments wherein the molded part 18 is a beverage container preform 19, the first and second split inserts 47 and 48 may cooperate to form the threaded portion, shown at 50 and at least a portion of the support ledge, shown at 52. A plurality of first slide bars 54 extend vertically, each holding a column of the first split inserts 47. The first slide bars 54 are all connected together by connecting bars (not shown), which extend horizontally above and below the mold cavity area of the first mold half base 20. A plurality of second slide bars 56 extend vertically, each holding a column of the second split inserts 48. The second slide bars 56 are all connected together by connecting bars (not shown), which extend horizontally above and below the mold cavity area of the first mold half base 20. The first and second split inserts 47 and 48 are movable apart and together during certain portions of the operation of the injection molding machine along a horizontal axis As which is perpendicular to the mold opening axis Am. They may be movable by any suitable means such as by cams (not depicted) which operate as a result of movement of the stripper plate 45.

In an alternative embodiment, the first and second split inserts 47 and 48 could be configured to open and close along a vertical axis instead of the horizontal axis As.

The stripper plate driver 46 may be any suitable type of driver, such as, for example, a hydraulic cylinder.

Referring to FIG. 1a, the second mold half 14 is movable by a driver (not depicted) along the mold opening axis Am to open and close the mold cavities 16. The second mold half 14 includes a second mold half base 58, a first sub-assembly 62, a second sub-assembly 60 and a shift structure 64.

The first sub-assembly 62 includes a first sub-assembly base 78, a first sub-assembly driver 80 and a plurality of first sub-assembly cores 82. The second sub-assembly 60 includes a second sub-assembly base 66, a second sub-assembly driver 68, and a plurality of second sub-assembly cores 70.

In the position shown in FIG. 1a, the first sub-assembly cores 82 extend through apertures in the second sub-assembly base 66, out through apertures in the shift structure 64, through apertures 74 (FIG. 1b) in the stripper plate 45 and into the first mold half cavity portions 24 on the first mold half base 20 to assist in defining the mold cavities 16. The first sub-assembly cores 82 may be cooling devices and may thus be cooled by some suitable means, so that they can assist in cooling the molded parts 18 in the mold cavities 16. For example, the first sub-assembly cores 82 may be hollow along all or some portion of their length, and a coolant may be circulated in their interior to transport heat away, as is known in the art. It will be understood that the term ‘core’ as used for cores 82 and 70 is intended to mean a male portion.

The first sub-assembly driver 80 may be any suitable means for positioning the first sub-assembly 62 as appropriate during operation of the machine. The first sub-assembly driver 80 may comprise, for example, a pair of hydraulic cylinders 84 (one of the hydraulic cylinders 84 is not shown in FIG. 1a as FIG. 1a is a sectional view). The hydraulic cylinders 84 may optionally pass through apertures 76 in the second mold half base 58 and may further pass through apertures in the first sub-assembly base 78.

In the position shown in FIG. 1a, the second sub-assembly cores 70 extend out through apertures in the shift structure 64, through apertures 74 in the stripper plate 45 (FIG. 1b) and into the second cooling cavities 34b. In the position shown in FIG. 1a, the second sub-assembly cores 70 are used in the cooling of the molded parts 18 in the second cooling cavities 34b. To accomplish the cooling, the second sub-assembly cores 70 may themselves be cooling devices. The second sub-assembly cores 70 may, for example, have similar cooling means to the first sub-assembly cores 82. An advantage to using a core 70 to cool a molded part 18 is that the molded part 18 remains in intimate contact with the second sub-assembly core 70 throughout the cooling. By contrast, cooling a molded part 18 by cooling the first mold half cavity portion 24 results in a progressively less effective heat transfer out of the molded part 18 as the molded part 18 shrinks as a result of thermal contraction and pulls away from the wall of the first mold half cavity portion 24.

The second sub-assembly driver 68 may be any suitable means for positioning the second sub-assembly 60 as appropriate during operation of the machine. The second sub-assembly driver 68 may comprise, for example, a pair of hydraulic cylinders 75. The hydraulic cylinders 75 may pass through apertures 76 in the second mold half base 58.

The first and second sub-assemblies 62 and 60 are at least partially independently movable relative to the second mold half base 58, along the axis Am.

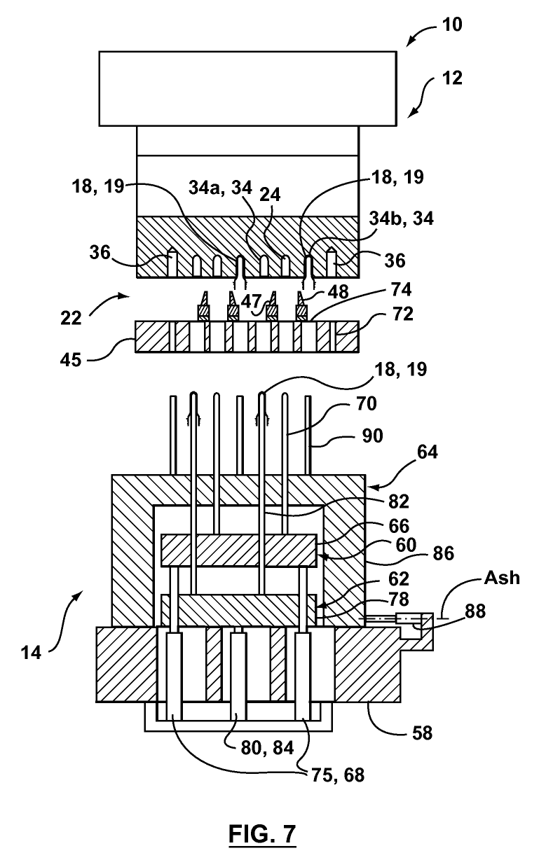

The shift structure 64 is movably mounted to the second mold half base 58 for movement along an axis Ash, which may be horizontal and perpendicular to the mold opening axis Am. The shift structure 64 is movable between a first position, shown in FIG. 1a, and a second position, shown in FIG. 7.

The shift structure 64 holds the first and second sub-assemblies 62 and 60 and moves them laterally as it moves between its first and second positions. The shift structure 64 includes a frame 86, a shift structure driver 88 and a plurality of blow tubes 90. The blow tubes 90 extend through apertures shown at 72 and 74 in the stripper plate 45 in FIG. 1b, and into dummy cavities 36 or cooling cavities 34. In the position shown in FIG. 1a, the blow tubes 90 extend into the first cooling cavities 34a specifically. The blow tubes 90 transport a cooling medium to molded parts 18 that are present in the first cooling cavities 34a to assist in cooling the molded parts 18.

In general, the molded parts 18 are formed in the mold cavities 16 and are then cooled in three stages. In the first stage, the molded part 18 is cooled in the mold cavity 16 sufficiently for its removal from the mold cavity 16. The molded parts 18 are then removed from the mold cavities 16 and are placed either in the first cooling cavities 34a or in the second cooling cavities 34b. Regardless of which of the first cooling cavities 34a or the second cooling cavities 34b they are placed in, each molded part 18 is further cooled in two post-molding stages. In the first post-molding stage, whichever of the first or second sub-assembly cores 70 or 82 that is positioned in the molded part 18 cools the molded part 18. In the second post-molding stage a blow tube 90 extends into contained volume of the molded part 18 and transports a cooling medium to the molded part 18 to further cool the molded part 18.

In the position shown in FIGS. 1a and 1b, the mold 10 is closed. The first sub-assembly cores 82 extend into the first mold half cavity portions 24 and the first and second split inserts 47 and 48 are closed, thereby forming the mold cavities 16. Material (eg. polymeric material) is injected into the mold cavities 16 and then cooled in the mold cavities 16 to at least partially solidify the molded parts 18. The molded parts 18 are cooled sufficiently so that they can be removed from the mold cavities 16. The second sub-assembly cores 70 are positioned in the second cooling cavities 34b to cool molded parts 18 that are held there. Blow tubes 90 extend into the contained volumes of molded parts 18 held in the first cooling cavities 34a to cool them. It will be understood that, initially, (ie. prior to running the molding machine), no molded parts 18 will be present in the first and second cooling cavities 34a and 34b. In other words, FIGS. 1a and 1b illustrate the mold 10 after already having been in use for several molding cycles.

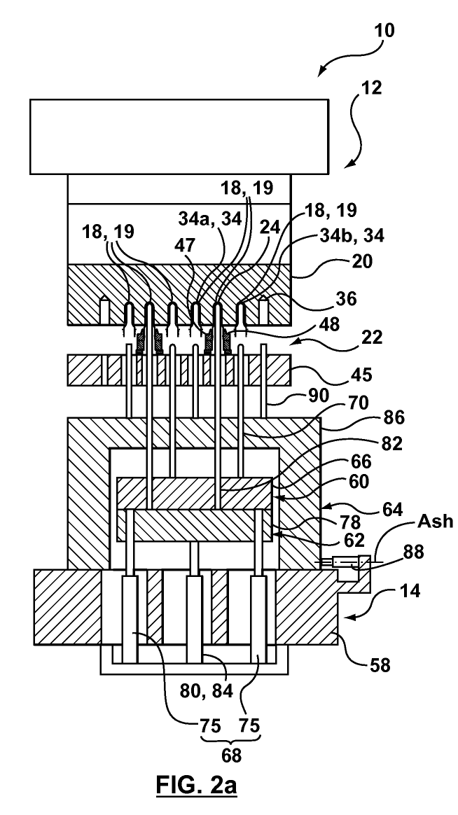

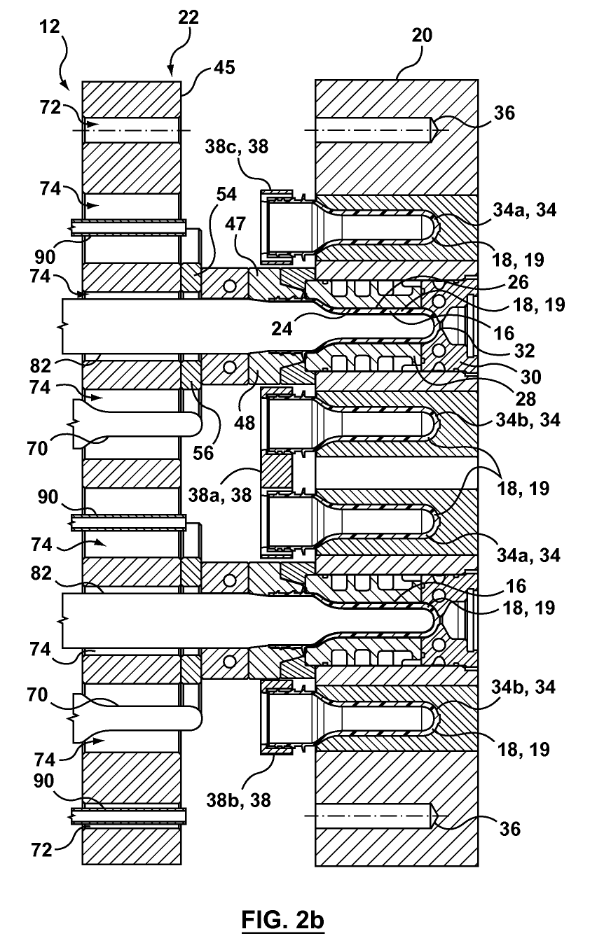

At the appropriate time, the second mold half base 58 is moved away from the first mold half base 20, which withdraws the blow tubes 90 from the first cooling cavities 34a and the dummy cavities 36, as shown in FIGS. 2a and 2b. In addition, the second sub-assembly base 66 is moved away from the first mold half base 20 to withdraw the second sub-assembly cores 70 from the second cooling cavities 34b. Prior to removing the second sub-assembly cores 70 from the second cooling cavities 34b, the retainer plates 38 are positioned so that the small diameter portions 42 (FIG. 1d) of the second apertures 40b are in front of the second cooling cavities 34b to prevent the removal of the molded parts 18 from the second cooling cavities 34b when the second sub-assembly cores 70 are removed from the second cooling cavities 34b. The first sub-assembly cores 82 (FIG. 2a) are not withdrawn from the mold cavities 16, however—they remain stationary relative to the first mold half base 20. To achieve this, the hydraulic cylinders 84 are extended at the same rate that the second mold half base 58 is moved away from the first mold half base 20.

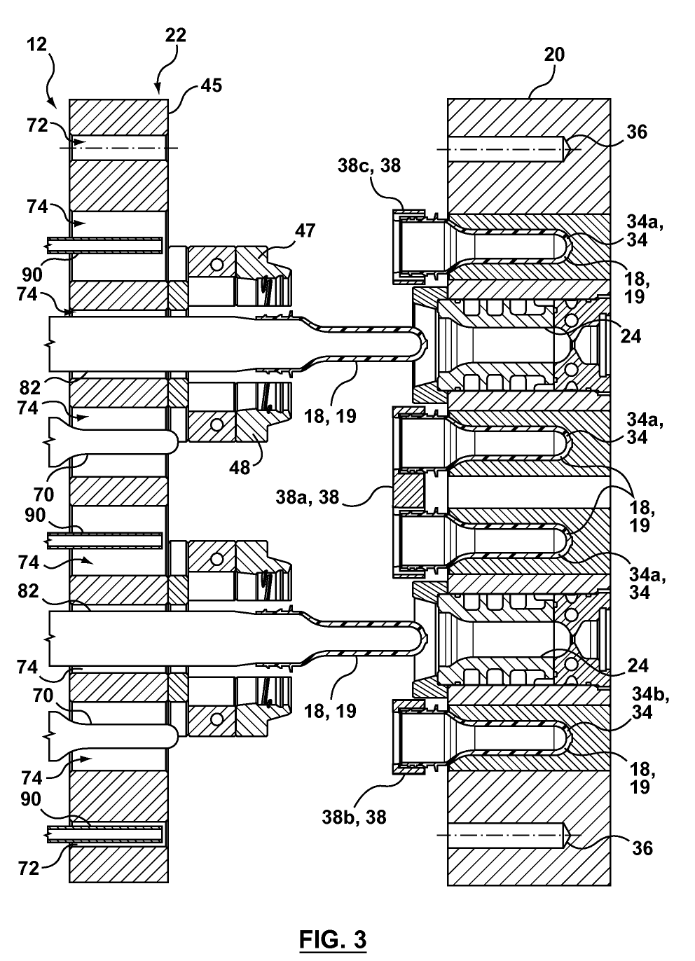

When the second mold half base 58 has moved away by a selected amount from the first mold half base 20, the stripper plate 45 and the first sub-assembly cores 82 are moved away from the first mold half base 20. When the stripper plate 45 is at a selected distance from the first mold half base 20 and when the second sub-assembly cores 70 and the blow tubes 90 are withdrawn sufficiently out of the paths of the first and second slide bars 54 and 56, the first and second split inserts 47 and 48 are moved apart (see FIG. 3). The molded parts 18 remain on the first sub-assembly cores 82.

By providing the first and second sub-assembly cores 82 and 70 and the blow tubes 90 that all move independently of one another, one set of cores, (in FIG. 3, it is the second sub-assembly cores 70) and the blow tubes 90 can move out of the way of the first and second split insert assemblies during opening of the first and second split inserts 47 and 48. This permits the first and second sub-assembly cores 82 and 70 and the blow tubes 90 to be closer to one another than would be possible if all of those elements were mounted to a single common plate. Thus, this permits the mold cavity pitch to be smaller, which increases the capacity of a given size of mold 10.

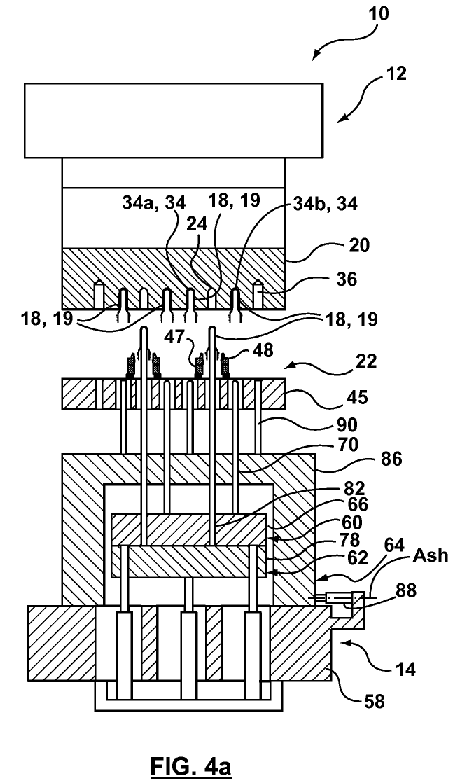

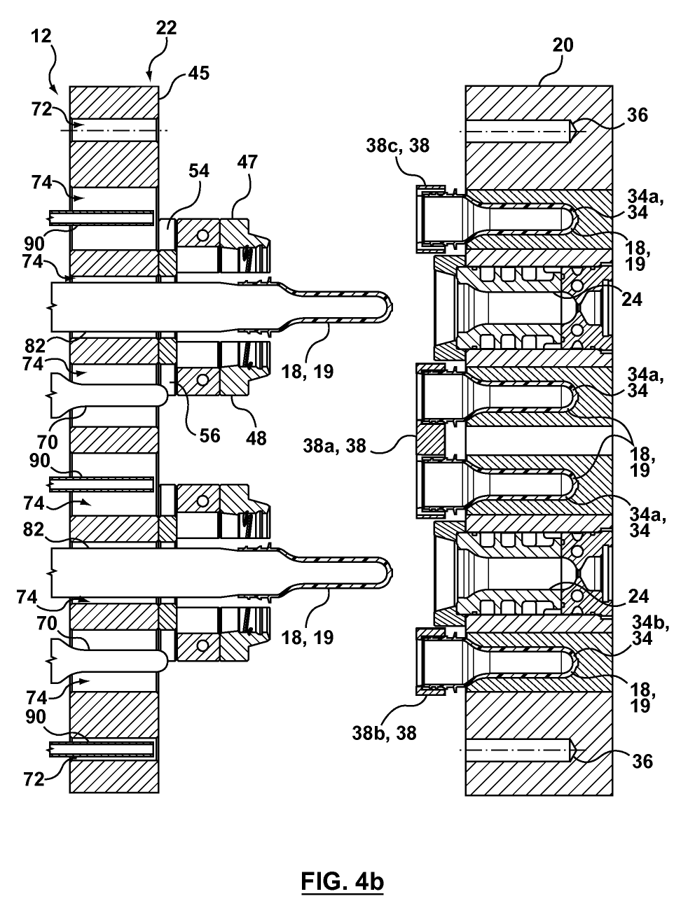

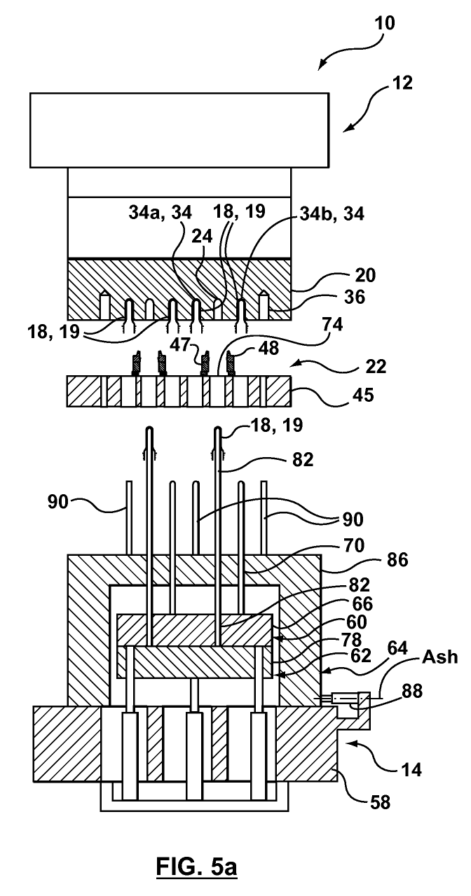

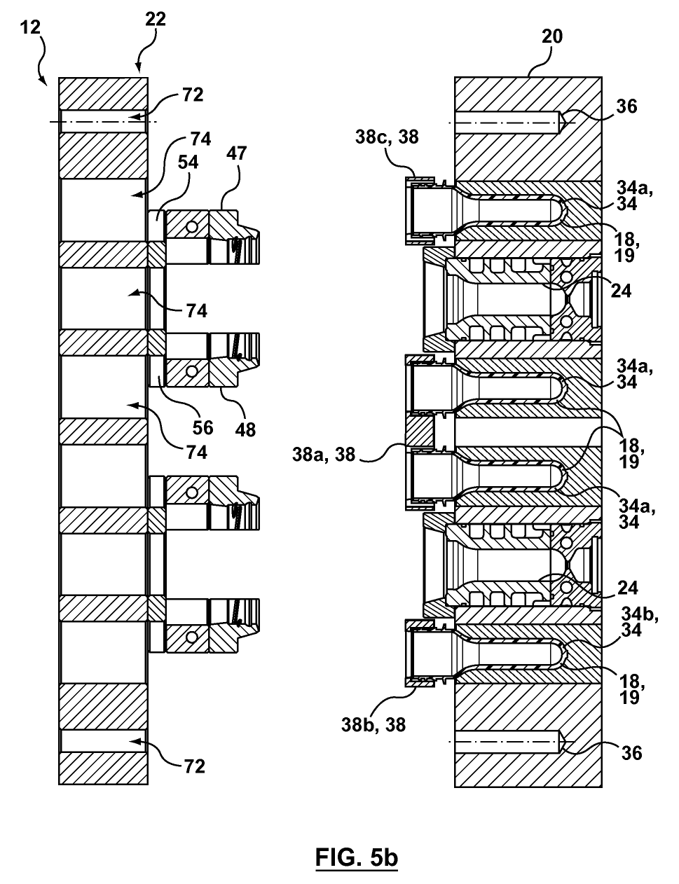

The second mold half base 58 and the stripper plate 45 continue to move away from the first mold half base 20, to the position shown in FIGS. 4a and 4b. In the position shown in FIGS. 4a and 4b, the stripper plate 45 is at its maximum travel away from the first mold half base 20. The second mold half base 58 continues to move away from the first mold half base 20 and from the stripper plate 45, and more particularly, the first sub-assembly cores 82 are withdrawn completely through the apertures 74 in the stripper plate 45 along with the molded parts 18, to a position shown in FIG. 5a. Additionally, in this position, the second sub-assembly cores 70 and the blow tubes 90 are withdrawn completely through the apertures 74 and 72.

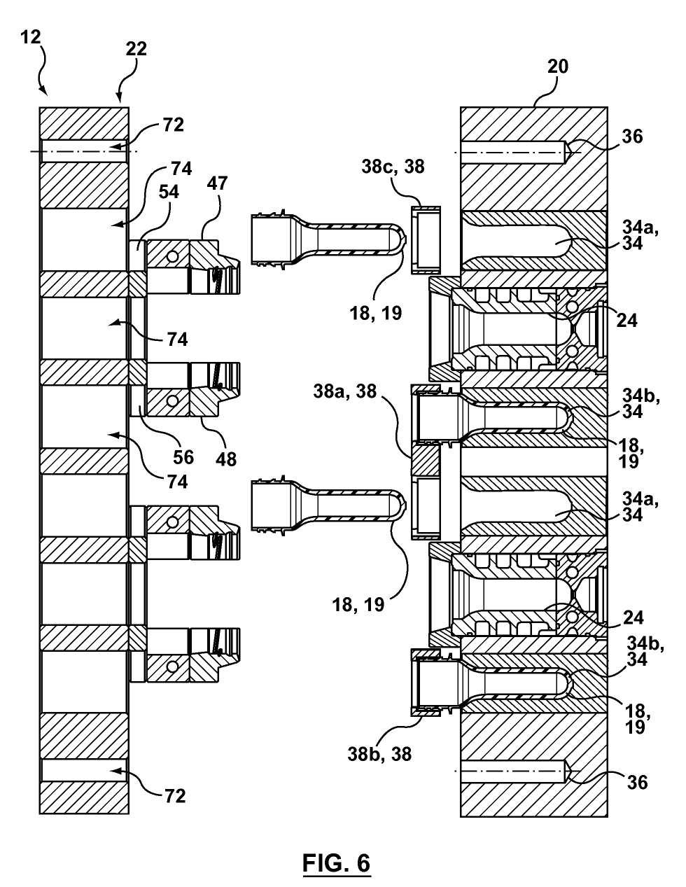

When the second sub-assembly cores 70 have been sufficiently withdrawn, and the stripper plate 45 is sufficiently far away from the first mold half base 20, and the retainer plates 38 are positioned as shown in FIG. 1d, the molded parts 18 in the first cooling cavities 34a may be ejected, as shown in FIG. 6. The molded parts 18 may be ejected by any suitable means. For example, a robot with suitable end-of-arm tooling may move into the space between the stripper plate 45 and the first mold half base 20. An advantage provided by the mold 10 is that the end-of-arm tooling on such a robot would not need to have any cooling structure thereon, in contrast to some robots used on prior art machines where post-molding cooling of parts takes place. Eliminating the need for cooling structure on the end-of-arm tooling lightens it, which makes it easier and quicker to move it into and out of the mold to remove the molded parts 18.

It will be noted that in some machines of the prior art the cores are removed from the molded parts and separate (ie. distinct), internally cooled end-of-arm tooling is used to remove the molded parts from the mold cavities for one or more stages of post-molding cooling. That prior art process thus entails the removal of the cores from the molded parts before the molded parts have undergone any post-molding cooling. If a short molding cycle time is needed, this means that the molded parts may be relatively warmer and relatively less stable structurally, and thereby a risk exists that the molded parts will deform during removal of the cores therefrom. If the molding cycle time is lengthened to permit the molded parts to be further cooled to inhibit them from deforming when being removed from the cores, this reduces the number of molding cycles per unit of time for the molding machine. Thus, there is a tradeoff in terms of molding cycle time and percentage of reject parts and overall machine capacity that exists with respect to some prior art molding machines. By contrast, in the mold 10, the first or second sub-assembly cores 70 or 82 (depending on what step in the overall operating cycle the machine is at) remain in the molded parts 18 for the first post-molding cooling stage (ie. for a longer period of time than is provided for on some prior art machines). This permits the molded parts 18 to become cooler and more structurally stable before the first or second sub-assembly cores 70 or 82 are eventually removed, thereby reducing the risk of deforming the molded parts 18 during removal of the first or second sub-assembly cores 70 or 82.

Alternatively, the molded parts 18 may simply be ejected using pressurized air at one or more selected positions in the first cooling cavities 34a. Air conduits to the first cooling cavities 34a have not been depicted in the figures. In this alternative, a parts collector or conveyor (not depicted) would be positioned underneath the machine to catch the ejected molded parts 18.

Once the molded parts 18 have been ejected, the stripper plate 45 is moved to the position shown in FIG. 7, closing the first and second split inserts 47 and 48 together and bringing them into engagement with the first mold half base 20. The first and second split inserts 47 and 48 are shown in FIG. 7 spaced slightly from the first mold half base 20, however this is because certain components that are part of the first mold half base 20 have been omitted from the figure for greater clarity of the figure. The engagement of the first and second split inserts 47 and 48 and the first mold half base 20 is more clearly illustrated in FIG. 8b, which shows the first and second split inserts 47 and 48 in the same position as they are in FIG. 7. Referring again to FIG. 7, the shift structure 64 is shifted to its second position to bring the second sub-assembly cores 70 into alignment with the first mold half cavity portions 24, to bring the first sub-assembly cores 82 with the molded parts 18 thereon into alignment with the first cooling cavities 34a, and to bring the blow tubes 90 into alignment with the second cooling cavities 34b and the dummy cavities 36.

The second mold half base 58 is then moved towards the first mold half base 20 thereby moving the first sub-assembly cores 82 with the molded parts 18 thereon through apertures 74 in the stripper plate 45, through the retainer plate 38 and into the first cooling cavities 34a, where the first sub-assembly cores 82 cool the molded parts 18 as part of the first post-molding cooling stage for those molded parts 18, as shown in FIGS. 8a and 8b. It will be understood that coolant flow may take place in the first sub-assembly cores 82 throughout the entire time they hold the molded parts 18 out of the mold cavities 16, and not just when they hold the molded parts 18 in the first cooling cavities 34a, thereby hastening the cooling of the molded parts 18.

Additionally, the blow tubes 90 are moved into the interiors of the molded parts 18 in the second cooling cavities 34b to transport a cooling medium to the molded parts 18 in the second post-molding stage of cooling for the molded parts 18 in those second cooling cavities 34b.

The movement of the second mold half base 58 also moves the second sub-assembly cores 70 through the apertures 74 in the stripper plate 45, through the first and second split inserts 47 and 48 and into the first mold half cavity portions 24 thereby forming the mold cavities 16.

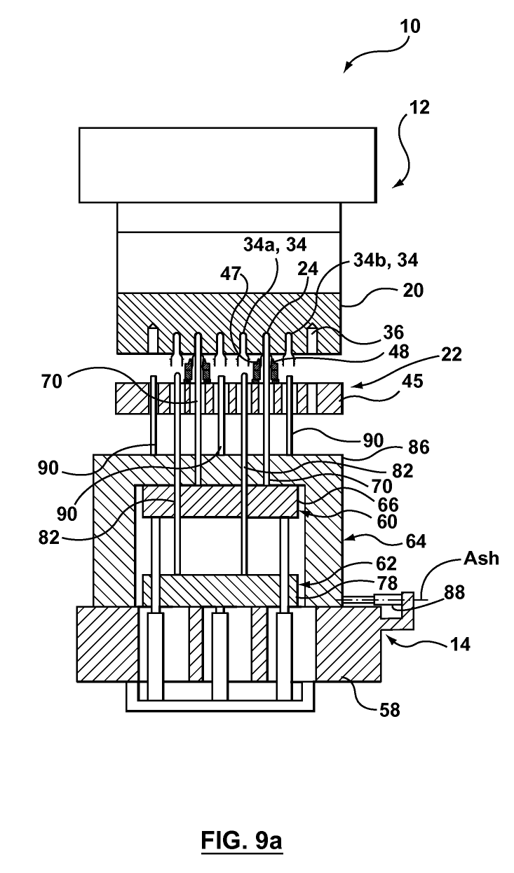

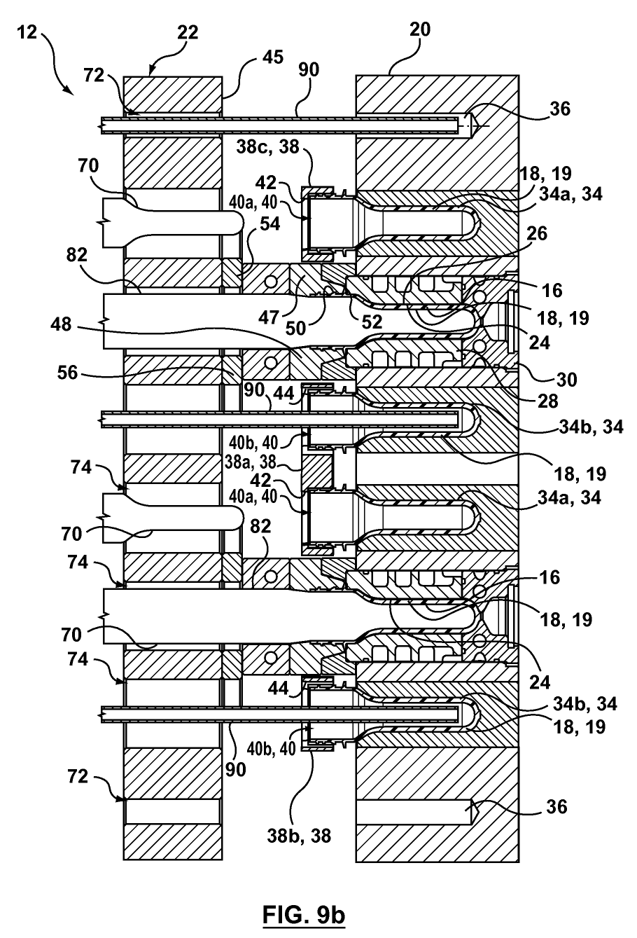

Once the second sub-assembly cores 70 are in position and the mold cavities 16 are formed, material may be injected into the mold cavities 16 and new molded parts 18 may be formed and cooled. At the appropriate time, the second mold half base 58 is moved away from the first mold half base 20, which withdraws the blow tubes 90 from the second cooling cavities 34b and from the dummy cavities 36, as shown in FIGS. 9a and 9b. In addition, the first sub-assembly base 78 is moved away from the first mold half base 20 to withdraw the first sub-assembly cores 82 from the first cooling cavities 34a. Prior to removing the first sub-assembly cores 82 from the first cooling cavities 34a, the retainer plates 38 are positioned so that the small diameter portions 42 (FIG. 9b) of the first apertures 40a are in front of the first cooling cavities 34a to prevent the removal of the molded parts 18 from the first cooling cavities 34a when the first sub-assembly cores 82 are removed from the first cooling cavities 34a. The second sub-assembly cores 70 are not withdrawn from the mold cavities 16, however—they remain stationary relative to the first mold half base 20. To achieve this, the hydraulic cylinders 75 are extended at the same rate that the second mold half base 58 is moved away from the first mold half base 20.

When the second mold half base 58 has moved away by a selected amount from the first mold half base 20, the stripper plate 45 and the second sub-assembly cores 70 are moved away from the first mold half base 20. When the stripper plate 45 is at a selected distance from the first mold half base 20 and when the first sub-assembly cores 82 and the blow tubes 90 are withdrawn sufficiently out of the paths of the first and second slide bars 54 and 56, the first and second split inserts 47 and 48 are moved apart. The molded parts 18 remain on the second sub-assembly cores 70.

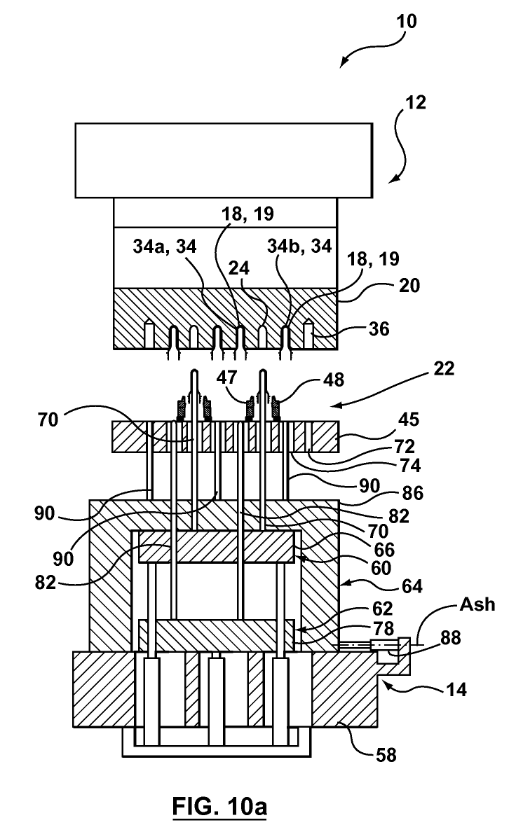

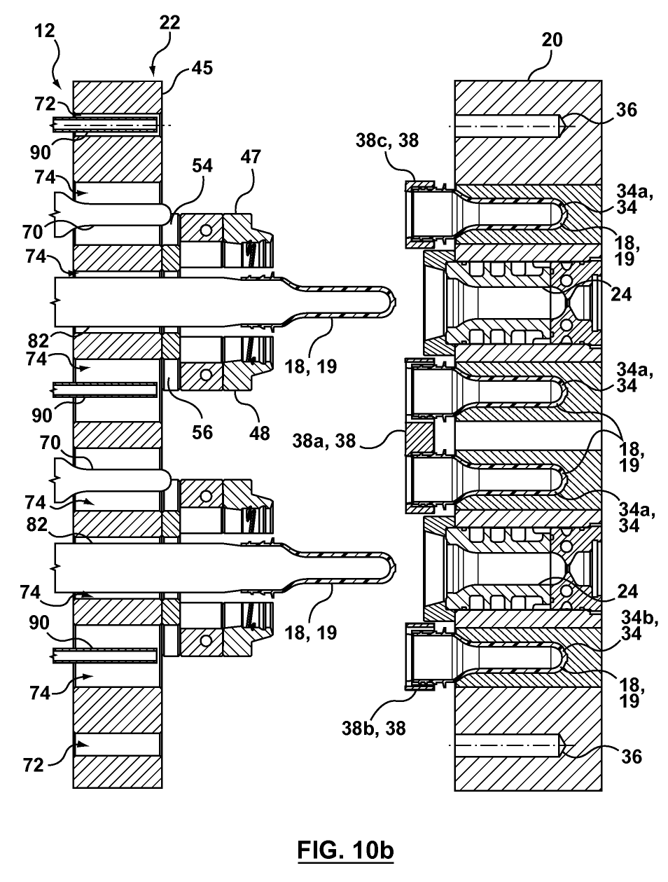

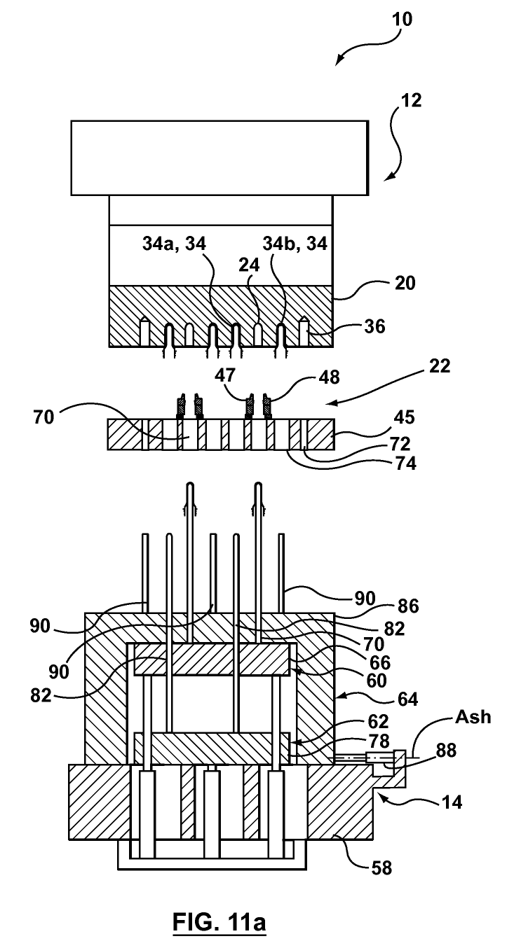

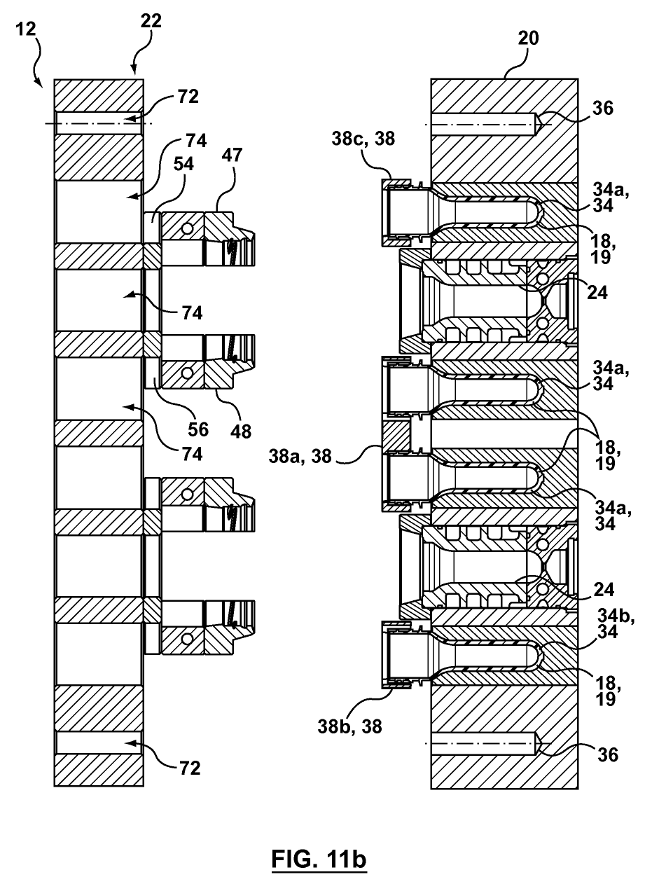

The second mold half base 58 and the stripper plate 45 continue to move away from the first mold half base 20, to the position shown in FIGS. 10a and 10b. In the position shown in FIGS. 10a and 10b, the stripper plate 45 is at its maximum travel away from the first mold half base 20. The second mold half base 58 continues to move away from the first mold half base 20 and from the stripper plate 45, and more particularly, the second sub-assembly cores 70 are withdrawn completely through the apertures 74 in the stripper plate 45 along with the molded parts 18, to a position shown in FIG. 11a. Additionally, in this position, the first sub-assembly cores 82 and the blow tubes 90 are withdrawn completely through the apertures 74 and 72.

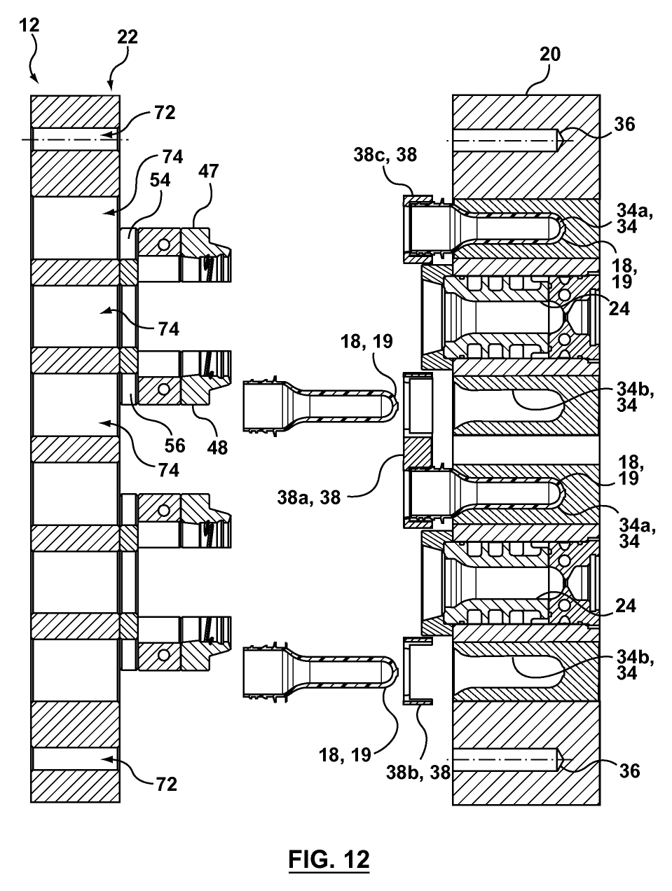

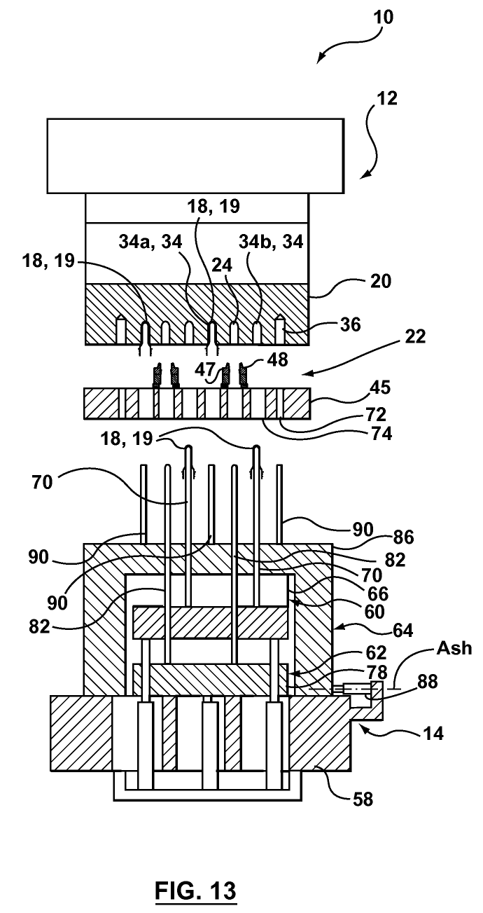

When the first sub-assembly cores 82 have been sufficiently withdrawn, and the stripper plate 45 is sufficiently far away from the first mold half base 20, and the retainer plates 38 are positioned with the large diameter portions 44 of the second apertures 40b in front of the second cooling cavities 34b, the molded parts 18 in the second cooling cavities 34b may be ejected, as shown in FIG. 12. The molded parts 18 may be ejected by any suitable means, as described above with respect to FIG. 6. Once the molded parts 18 have been ejected, the stripper plate 45 is moved to the position shown in FIG. 13, closing the first and second split inserts 47 and 48 together and bringing them into engagement with the first mold half base 20. Similarly to FIG. 7, the first and second split inserts 47 and 48 are shown in FIG. 13 spaced slightly from the first mold half base 20, however this is because certain components that are part of the first mold half base 20 have been omitted from the figure for greater clarity of the figure. The engagement of the first and second split inserts 47 and 48 with the first mold half base 20 is more clearly illustrated in FIG. 1b, which shows the first and second split inserts 47 and 48 in the same position as they are in FIG. 13. Referring again to FIG. 13, the shift structure 64 is shifted to its first position, to bring the first sub-assembly cores 82 into alignment with the first mold half cavity portions 24, to bring the second sub-assembly cores 70 with the molded parts 18 thereon into alignment with the second cooling cavities 34b, and to bring the blow tubes 90 into alignment with the first cooling cavities 34a and the dummy cavities 36.

The second mold half base 58 is then moved towards the first mold half base 20 thereby moving the second sub-assembly cores 70 with the molded parts 18 thereon through apertures 74 in the stripper plate 45, through the retainer plates 38 and into the second cooling cavities 34b, where the first sub-assembly cores 82 cool the molded parts 18 as part of the first post-molding cooling stage for those molded parts 18, as shown in FIGS. 1a and 1b. It will be understood that coolant flow may take place in the second sub-assembly cores 70 throughout the entire time they hold the molded parts 18 out of the mold cavities 16, and not just when they hold the molded parts 18 in the second cooling cavities 34b, thereby hastening the cooling of the molded parts 18.

Additionally, the blow tubes 90 are moved into the contained volumes of the molded parts 18 in the first cooling cavities 34a to transport a cooling medium to the molded parts 18 in the second post-molding stage of cooling for the molded parts 18 in those first cooling cavities 34a.

The movement of the second mold half base 58 also moves the first sub-assembly cores 82 through the apertures 74 in the stripper plate 45, through the first and second split inserts 47 and 48 and into the first mold half cavity portions 24 thereby forming the mold cavities 16, as shown in FIGS. 1a and 1b.

With respect to the above described method, and as shown in FIGS. 1a and 1b, a first molded part 18 is molded in the mold cavities 16 using the first sub-assembly core 82, and a second molded part 18 is cooled in the second cooling cavity 34b using the second sub-assembly core 70. After a sufficient period of time, the first molded part 18 is removed from the mold cavity 16 (see FIG. 3). After a further period of time, the mold cavity 16 is closed and a third molded part 18 is formed in the mold cavity 16 (see FIGS. 8a and 8b). As further shown in the figures, the blow tube 90 cools a fourth molded part 18 in the first cooling cavities 34a, while the first molded part 18 is being molded.

The method of molding molded parts 18 illustrated in the figures, shows the mold at several selected positions. It will be understood that there may be overlap in at least some of the movements that take place in the mold 10. For example, it will be understood that the blow tubes 90 and the first or second sub-assembly cores 70 or 82 do not need to be completely removed from the paths of the first and second split insert assemblies before the first and second split inserts 47 and 48 can begin to open; along some initial portion of the path the first and second split insert assemblies there is no risk of interference with the blow tubes 90 and the first or second sub-assembly cores 70 or 82. As another example, the shifting of the shift structure 64 and the movement of the stripper assembly 22 towards the first mold half base 20, (see FIG. 7) could take place simultaneously.

With respect to the operation of the retainer plates 38, FIG. 1d illustrates the retainer plate 38a in a first position, wherein the large diameter portion 44 of the first aperture 40a is aligned with a first molded part 18 in the first cooling cavity 34a, and wherein the small diameter portion 42 of the second aperture 40b is aligned with a second molded part 18 in the second cooling cavity 34b. FIG. 9b illustrates the retainer plate 38a in a second position, wherein the small diameter portion 42 of the first aperture 40a is aligned with a first molded part 18 in the first cooling cavity 34a, and wherein the large diameter portion 44 of the second aperture 40b is aligned with a second molded part 18 in the second cooling cavity 34b.

For the mold 10 shown in the figures, providing two sets of cores (ie. the first and second sub-assembly cores 82 and 70) facilitates movement of molded parts 18 out of the mold cavities 16 and into cooling cavities 34 where these parts are further cooled relatively efficiently while other molded parts 18 are being manufactured in the mold cavities 16. This is a relatively less expensive solution than some other technologies proposed to permit post-molding cooling of molded parts. For example, some other technologies propose the use of two sets of split inserts which are used to hold molded parts for post-molding cooling. Split inserts are typically relatively more expensive than cores, and so accomplishing post-molding cooling using two sets of cores (ie. the first and second sub-assembly cores 82 and 70) represents a cost savings over using two sets of inserts.

The mold 10 is shown in FIGS. 1a and 1b with the first sub-assembly cores 82 cooperating with the first mold half cavity portions 24 to form mold cavities 16. This is not intended to imply that the mold 10 necessarily starts off in that position. At the beginning of a molding campaign, it is alternatively possible for the mold 10 to start in the position shown in FIGS. 8a and 8b.

As illustrated in FIGS. 6 and 12, the stripper plate 45 has been shown as being capable of moving sufficiently far from the first mold half base 20 to permit the molded parts 18 to be ejected from the first mold half base 20 in the space between the first mold half base 20 and the stripper plate 45. In an alternative embodiment, however, the stripper plate 45 could be positioned in close proximity to the first mold half base 20 during the ejection of the molded parts 18. In this alternative embodiment, the molded parts 18 could be ejected from the cooling cavities 34 through the apertures 74 in the stripper plate 45 and down onto suitable parts handling means. The ejection of the molded parts 18 may be by any suitable means, such as, for example, using pressurized air from within the cooling cavities 34. By ejecting the molded parts 18 through the apertures 74 in the stripper plate 45, the stripper plate 45 need not be capable of having as great a stroke. The stripper plate 45 can be moved along the axis As a sufficient amount to open and close the first and second split insert assemblies, and need not be capable of any greater range of movement than that. By reducing the necessary stroke of the stripper plate 45, there is less likelihood of misalignment between the stripper plate 45 and its intended position. This, in turn, reduces potential stresses on the components that support the stripper plate 45. Reducing the necessary stroke of the stripper plate 45 could in turn reduce the necessary stroke of the second mold half 14, which, among other things, reduces the overall space required by the mold 10 during operation.

It will be noted that, in the mold 10, the cooling cavities 34 are included on the stationary mold half 12. Thus, any cooling structure associated with the cooling cavities 34 is not required to move. This reduces the complexity of the mold 10, relative to some machines of the prior art which include a plenum with cooling cavities thereon (referred to sometimes as cooling tubes), which are typically indexed between several positions for receiving, cooling and ejecting molded parts.

The first and second sub-assembly cores 82 and 70 have been described as both including structure to permit them to cool molded parts 18. It is optionally possible that they could be provided without any cooling structure therein. In such an embodiment, when the molded parts 18 are in the mold cavity 16, they could be cooled by coolant flow in the fluid conduit 33 (FIG. 1b) around the first mold half cavity portion 24. When the molded parts 18 are in one of the cooling cavities 34, they could be cooled by coolant flow in cooling conduits (not depicted) around the cooling cavities 34. Additionally, the molded parts 18 can also be cooled using the blow tubes 90 in a second post-molding stage of cooling. Because the first and second sub-assembly cores 82 and 70 hold the molded parts 18 in the first mold half cavity portions 24 and the cooling cavities 34, the first and second sub-assembly cores 82 and 70 are still used for the cooling of the molded parts 18 even though they may lack cooling structure themselves. Such an embodiment is beneficial in that the molded parts 18 can be removed from the mold cavities 16 to permit other molded parts 18 to be formed in the mold cavities 16, but they remain on the first or second sub-assembly cores 82 or 70 (depending on which step in the overall cycle the machine is at) for further cooling before having the first or second sub-assembly cores 82 or 70 removed therefrom.

In FIGS. 4a and 5a the first sub-assembly 62 is shown in an advanced position whereby its base 78 is in abutment with the second sub-assembly base 66. It is alternatively possible for the first sub-assembly base 78 to be retracted towards the second mold half base 58. It is further possible for the second sub-assembly base 66 to also be retracted towards the second mold half base 58, once the first and second split inserts 47 and 48 are opened.

In FIG. 10a the second sub-assembly 60 is shown in an advanced position whereby the second sub-assembly base 66 is in abutment with the frame 86 of the shift structure 64. It is alternatively possible for the second sub-assembly base 66 to be retracted towards the second mold half base 58, once the first and second split inserts 47 and 48 are opened.

In FIG. 11a the first sub-assembly 62 is shown in a retracted position whereby the first sub-assembly base 78 is in abutment with the second mold half base 58. It is alternatively possible for the second sub-assembly base 66 to be advanced towards the shift structure 64, though it would require that the second mold half 14 be moved further away from the stripper plate 45 to ensure that the first sub-assembly cores 82 are out of the paths of the first and second split insert assemblies.

The stripper assembly 22 has been described as being movably connected to the first, or stationary, mold half 12. By contrast, a typical stripper assembly on a prior art injection molding machine is connected to the moving mold half. However, the presence of the shift structure 64 obscures much of the second mold half base 58 and thereby makes mounting the stripper assembly 22 to the second mold half base 58 relatively difficult. Additionally, the shift structure 64 and the first and second sub-assemblies 62 and 60 increase the distance between the second mold half base 58 and the first mold half base 20. As a result of the increased distance, it would be relatively difficult to connect the stripper plate 45 to the second mold half base 58 and maintain alignment between the first and second split inserts 47 and 48 and the first mold half cavity portion 24. By contrast, it is relatively easier to maintain such alignment with the stripper assembly 22 mounted to the first mold half base 20, since the distance along mold opening axis Am from the stripper plate 45 to mounting points (not shown) on the first mold half base 20 is smaller than the distance would be from the stripper plate 45 to hypothetical mounting points (not shown) on the second mold half base 58.

Additionally, by connecting the stripper assembly 22 to the first mold half base 20, the movable mold half 14 has reduced weight and is therefore easier and faster to move along the mold opening axis Am.

In an alternative embodiment that is not depicted, it is possible for the system to insert a cooled core into the molded part 18 in the second further stage instead of inserting a blow tube 90. The cooled core may be used, for example, in embodiments wherein the molded part 18 would need more cooling than could be achieved with a blow tube 90.

In another alternative embodiment that is not depicted, the injection molding machine includes only one further stage of cooling using cooled cores after the molded part 18 is removed from the mold cavity 16, instead of including two further stages of cooling. In this alternative embodiment, the machine would include cooled cores and would not require blow tubes. A molded part 18 would, for example, be removed from a mold cavity 16 and would be transported on its core to a cooling cavity 34 while a second core would be inserted into the mold cavity 16, in similar fashion to the process shown in the embodiment shown in FIGS. 1-13, except that after the molded part 18 is cooled in the cooling cavity 34 by the core, the molded part 18 would be ejected. In such an embodiment each row of cavities on the first mold half base 20 would consist of an alternating pattern of a cooling cavity 34 followed by a mold cavity 16. At the end of each row would be a cooling cavity 34, with no mold cavity 16 thereafter.

The mold 10 described above has been described in relation to an injection molding machine. It is alternatively possible for the mold to be used as part of another type of machine, such as a combination injection- and blow-molding machine, compression molding machine, or a combination injection- and compression-molding machine. In general, the independent movement of the first and second sub-assembly cores 82 and 70 and the blow tubes 90 is advantageous where lateral movement of components such as the first and second split inserts 47 and 48 takes place and where a small cavity pitch is desired.

The first mold half cavity portions 24 may alternatively be any suitable first mold half molding structure. Similarly, the first and second sub-assembly cores 82 and 70 may alternatively be any suitable first and second sub-assembly molding structures.

It will be understood that the axes Am, As, Ash and Ar referred to herein are used principally to describe directions of movement (eg. vertical, horizontal), and are not intended to imply strict adherence to movement along a specific line.

The concepts described above may be adapted for specific conditions and/or functions, and may be further extended to a variety of other applications that are within the scope of the present invention. Having thus described the embodiments, it will be apparent that modifications and enhancements are possible without departing from the concepts as described. Therefore, what is to be protected by way of letters patent are limited only by the scope of the following claims:

1. A mold, comprising:
a first mold half;
a second mold half, wherein the first and second mold halves are configured to open and close, wherein the first and second mold halves are configured to capture a molded part therebetween when closed; and
a retainer plate, wherein the retainer plate is positioned between the first and second mold halves and defines an aperture having a first aperture portion that is sized to prevent the pass-through of the molded part, and a second aperture portion that is sized to permit the pass-through of the molded part during opening of the first and second mold halves, and wherein the retainer plate is movable to control which of the first and second aperture portions is aligned with the molded part.

2. A mold as claimed in claim 1, wherein one of the first and second mold halves includes a male portion that is sized to mate with the molded part, and wherein the first and second aperture portions are sized to permit the pass-through of the male portion.

3. A mold as claimed in claim 1, wherein the first mold half includes a cooling cavity for holding the molded part, and wherein the second mold half includes a male portion that is sized to mate with the molded part, and wherein the first and second aperture portions are sized to permit the pass-through of the male portion.

4. A mold as claimed in claim 1, wherein the molded part is a first molded part, and wherein the first mold half includes a first cooling cavity for holding the first molded part, wherein the first mold half includes a second cooling cavity for holding a second molded part,
and wherein the aperture is a first aperture, and wherein the retainer plate includes a second aperture having a first aperture portion that is sized to prevent the pass-through of the molded part, and a second aperture portion that is sized to permit the pass-through of the molded part during opening of the first and second mold halves, wherein the retainer plate is movable between a first position and a second position, wherein in the first position the first aperture permits the pass-through of the first molded part and the second aperture prevents the pass-through of the second molded part, and wherein in the second position the first aperture prevents the pass-through of the first molded part and the second aperture permits the pass-through of the second molded part.

5. A mold as claimed in claim 1, wherein the retainer plate is movable along a vertical axis.

6. A mold as claimed in claim 1, wherein the retainer plate is positioned between linear arrangements of mold cavities defined at least in part by the first and second mold halves.

7. A mold as claimed in claim 1, wherein the aperture is generally keyhole-shaped.

8. A mold as claimed in claim 1, wherein the first mold half includes a cooling cavity for holding the molded part, and wherein the second mold half includes a male portion that is sized to mate with the molded part, and wherein the first and second aperture portions are sized to permit the pass-through of the male portion.

9. A mold as claimed in claim 1, wherein the molded part is a first molded part, and wherein the first mold half includes a first cooling cavity for holding the first molded part, wherein the first mold half includes a second cooling cavity for holding a second molded part,
and wherein the second mold half includes a male portion that is sized to mate with the molded part, and wherein the first and second aperture portions are sized to permit the pass-through of the male portion,
and wherein the aperture is a first aperture, and wherein the retainer plate includes a second aperture having a first aperture portion that is sized to prevent the pass-through of the molded part, and a second aperture portion that is sized to permit the pass-through of the molded part during opening of the first and second mold halves, wherein the retainer plate is movable between a first position and a second position, wherein in the first position the first aperture permits the pass-through of the first molded part and the second aperture prevents the pass-through of the second molded part, and wherein in the second position the first aperture prevents the pass-through of the first molded part and the second aperture permits the pass-through of the second molded part.

10. A retainer plate for use with a mold having a first mold half and a second mold half configured to open and close, the first and second mold halves being configured to capture a molded part therebetween when closed, the retainer plate comprising:
a body positionable between the first and second mold halves, the body defining an aperture having a first aperture portion that is sized to prevent the pass-through of the molded part, and a second aperture portion that is sized to permit the pass-through of the molded part during opening of the first and second mold halves, the body configured to be moved, in use, to control which of the first and second aperture portions is aligned with the molded part.

11. A retainer plate as claimed in claim 10, wherein one of the first and second mold halves includes a male portion that is sized to mate with the molded part, and wherein the first and second aperture portions are sized to permit the pass-through of the male portion.

12. A retainer plate as claimed in claim 10, wherein the first mold half includes a cooling cavity for holding the molded part, and wherein the second mold half includes a male portion that is sized to mate with the molded part, and wherein the first and second aperture portions are sized to permit the pass-through of the male portion.

13. A retainer plate as claimed in claim 10, wherein the molded part is a first molded part, and wherein the first mold half includes a first cooling cavity for holding the first molded part, wherein the first mold half includes a second cooling cavity for holding a second molded part,
and wherein the aperture is a first aperture, and wherein the retainer plate includes a second aperture having a first aperture portion that is sized to prevent the pass-through of the molded part, and a second aperture portion that is sized to permit the pass-through of the molded part during opening of the first and second mold halves, wherein the retainer plate is movable between a first position and a second position, wherein in the first position the first aperture permits the pass-through of the first molded part and the second aperture prevents the pass-through of the second molded part, and wherein in the second position the first aperture prevents the pass-through of the first molded part and the second aperture permits the pass-through of the second molded part.

14. A retainer plate as claimed in claim 10, wherein the retainer plate is movable along a vertical axis.

15. A retainer plate as claimed in claim 10, wherein the aperture is generally keyhole-shaped.

16. A retainer plate as claimed in claim 10, wherein the first mold half includes a cooling cavity for holding the molded part, and wherein the second mold half includes a male portion that is sized to mate with the molded part, and wherein the first and second aperture portions are sized to permit the pass-through of the male portion.

17. A retainer plate as claimed in claim 10, wherein the molded part is a first molded part, and wherein the first mold half includes a first cooling cavity for holding the first molded part, wherein the first mold half includes a second cooling cavity for holding a second molded part,
and wherein the second mold half includes a male portion that is sized to mate with the molded part, and wherein the first and second aperture portions are sized to permit the pass-through of the male portion,
and wherein the aperture is a first aperture, and wherein the retainer plate includes a second aperture having a first aperture portion that is sized to prevent the pass-through of the molded part, and a second aperture portion that is sized to permit the pass-through of the molded part during opening of the first and second mold halves, wherein the retainer plate is movable between a first position and a second position, wherein in the first position the first aperture permits the pass-through of the first molded part and the second aperture prevents the pass-through of the second molded part, and wherein in the second position the first aperture prevents the pass-through of the first molded part and the second aperture permits the pass-through of the second molded part.
